(19) United States
(12) Patent Application Publication
(10) Pub. No.: US 2019/0098045 A1
(43) Pub. Date: Mar. 28, 2019

(54) BROWSER INJECTION PREVENTION METHOD, BROWSER CLIENT AND APPARATUS

(71) Applicant: BEIJING QIHOO TECHNOLOGY COMPANY LIMITED, Beijing (CN)

(72) Inventors: Zhuang DANG, Beijing (CN); Zhihui LIANG, Beijing (CN); Tianping WANG, Beijing (CN)

(73) Assignee: BEIJING QIHOO TECHNOLOGY COMPANY LIMITED, Beijing (CN)

(21) Appl. No.: 15/533,356

(22) PCT Filed: Nov. 17, 2015
(86) PCT No.: PCT/CN2015/094844

§ 371 Date: Jun. 5, 2017

(30) Foreign Application Priority Data
Dec. 5, 2014 (CN) 201410742770.3

(51) Int. Cl. H04L 29/06

(52) U.S. Cl. CPC H04L 63/1466; H04L 67/42

(57) ABSTRACT

The present invention discloses a browser injection prevention method, relating to the technical field of browsers. The method comprises: copying a source layered service provider chain table of a current browser to obtain a first layered service provider chain table; converting a source node to which access is not permitted, in the first layered service provider chain table, into a virtual node to obtain a converted second layered service provider chain table; wherein the virtual node implements an interface with each layered service provider and returns a null value; and controlling a network request of the current browser to be transmitted by means of the second layered service provider chain table.

### CROSS-REFERENCE TO RELATED APPLICATIONS

This application is the national stage of International Application No. PCT/CN2015/094844 filed Nov. 17, 2015, which claims the benefit of Chinese Patent Applications No. CN201410742770.3, filed Dec. 5, 2014, the entirety of which are incorporated herein by reference.

### FIELD OF TECHNOLOGY

The present invention relates to the technical field of browsers, and more particularly, to a browser injection prevention method, a browser client and apparatus having a browser client.

### BACKGROUND

A browser is a software that can display file contents of HyperText Mark-up Language (HTML) contained in web servers or file systems and allow users to interact with these files. Web browsers interact with the web serves primarily via HTTP protocols and obtain webpages, which are specified by a uniform resource locator (URL) and generally have a file format of HTML.

In the process of using the browser, other programs may inject layered service provider (LSP) nodes to the browser, that is, dynamic link libraries of the LSP are injected. These dynamic link libraries have a function of processing network requests sent by the browser in Winsock, for example, hijacking the browser: the network requests being redirected to unsafe webpages, unsafe webpages being automatically and repeatedly added to bookmarks, items that can't be changed or hidden appearing in IE tabs, acquiring login names and passwords on the webpages, etc. Therefore, dynamic link libraries injected by these programs are not safe for the users' browsers.

### SUMMARY

In view of the above problems, the present invention is proposed to provide a browser client and a corresponding browser injection prevention method, which may overcome or at least partially solve the above problems.

According to an aspect of the present invention, there is provided a browser injection prevention method, which comprises: copying a source layered service provider chain table of a current browser to obtain a first layered service provider chain table; converting a source node to which access is not permitted, in the first layered service provider chain table, into a virtual node to obtain a converted second layered service provider chain table; wherein the virtual node implements an interface with each layered service provider and returns a null value; and controlling a network request of the current browser to be transmitted by means of the second layered service provider chain table.

According to another aspect of the present invention, a browser client is further disclosed, including: a network component, configured to initiate a network request to be sent to a server; an injection prevention component, specifically comprising: a chain table copying module, configured to copy a source layered service provider chain table of a current browser to obtain a first layered service provider chain table; a chain table converting module, configured to convert a source node to which access is not permitted, in the first layered service provider chain table, into a virtual node to obtain a converted second layered service provider chain table; wherein the virtual node implements an interface with each layered service provider and returns a null value; and a request control module, configured to control the network request to be transmitted by means of the second layered service provider chain table.

According to still another aspect of the present invention, an apparatus having a browser client is further disclosed, which comprises: a processor, and a memory loading a plurality of executable instructions, the plurality of instructions comprising a method for executing following steps: initiating a network request to be sent to a server; copying a source layered service provider chain table of a current browser to obtain a first layered service provider chain table; converting, after acquiring the first layered service provider chain table, a source node to which access is not permitted, in the first layered service provider chain table, into a virtual node to obtain a converted second layered service provider chain table, wherein the virtual node implements an interface with each layered service provider and returns a null value; and controlling the network request to be transmitted by means of the second layered service provider chain table.

According to still another aspect of the present invention, there is provided a computer program, comprising a computer-readable code, wherein a terminal device is caused to execute the browser injection prevention method when the computer-readable code runs on the terminal device.

According to still another aspect of the present invention, there is provided a computer-readable medium, in which the computer program of the browser injection prevention method is stored.

According to the browser injection prevention method of the present invention, a source layered service provider (LSP) chain table used by a browser may be converted into a secure second LSP chain table; thus a procedure in which a network request sent down by the browser is subjected to processing by an insecure LSP node in an LSP chain table is avoided. Hence, the problem of other application programs injecting an insecure LSP node into the browser to hijack the browser is solved, and a beneficial effect of improving the browser security is obtained.

Described above is merely an overview of a technical solution of the present invention. In order to more apparently understand the technical means of the present invention to implement in accordance with the contents of specification, and to more readily understand above and other objectives, features and advantages of the present invention, particular embodiments of the present invention are provided hereinafter.

### BRIEF DESCRIPTION OF THE DRAWINGS

Through reading the detailed description of the following preferred embodiments, various other advantages and benefits will become apparent to those of ordinary skills in the art. Accompanying drawings are merely included for the purpose of illustrating the preferred embodiments and should not be considered as limiting of the present invention. Further, throughout the drawings, like reference signs are used to denote like elements. In the drawings:

FIG. 1 is a schematic flowchart of a browser injection prevention method according to an embodiment of the present invention;

FIG. 2 is a schematic flowchart of another browser injection prevention method according to an embodiment of the present invention;

FIG. 3 is a schematic flowchart of another browser injection prevention method according to an embodiment of the present invention;

FIG. 4 is a schematic flowchart of another browser injection prevention method according to an embodiment of the present invention;

FIG. 5 is a schematic flowchart of another browser injection prevention method according to an embodiment of the present invention;

FIG. 6 is a schematic flowchart of another browser injection prevention method according to an embodiment of the present invention;

FIG. 7 is a schematic structural diagram of a browser client according to an embodiment of the present invention;

FIG. 8 is a schematic structural diagram of a browser client according to an embodiment of the present invention;

FIG. 9 is a schematic structural diagram of a browser client according to an embodiment of the present invention;

FIG. 10 is a schematic structural diagram of a browser client according to an embodiment of the present invention;

FIG. 11 illustrates a schematic structural diagram of a browser client according to an embodiment of the present invention;

FIG. 12 illustrates a schematic structural diagram of a browser client according to an embodiment of the present invention;

FIG. 13 illustrates a schematic structural diagram of an apparatus having a browser client according to an embodiment of the present invention;

FIG. 14 illustrates a block diagram of a terminal device for executing the method according to the present invention; and

FIG. 15 illustrates a storage unit for maintaining or carrying a program code for implementing the method according to the present invention.

### DESCRIPTION OF THE EMBODIMENTS

The following will describe in more detail the exemplary embodiments of the present invention with reference to the accompanying drawings. Although the accompanying drawings display the exemplary embodiments of the present invention, it should be understood that the present invention may be implemented in various forms but not limited by the embodiments set forth herein. Instead, these embodiments are provided to more thoroughly understand the present invention, and completely convey the scope of the present invention to those skilled in the art.

### Embodiment I

Referring to FIG. 1, which illustrates a schematic flowchart of a browser injection prevention method according to the present invention, the method specifically may include following steps.

Step 110: copying a source layered service provider chain table of a current browser to obtain a first layered service provider chain table.

In practical application, other application programs may inject an LSP node into the browser according to traditional way. That is, a dynamic link library (DLL) of the LSP may be injected into the browser, the DLL of the LSP may be may be written into a registry (for example, written into a corresponding location of a registry HKEY_LOCAL_MACHINE\SYSTEM\CurrentControlSet\Services\WinSock2\Parameters), and relevant configuration information may be written into configuration information of the source LSP chain table, wherein the configuration information records information such as the location of the registry of the DLL. According to traditional way, after the browser is started and before a request is sent out, the source LSP chain table may be loaded according to the configuration information of the source LSP chain table of the browser. That is, the DLL of each node in the LSP chain table is loaded, and then a network request of the browser may be transmitted, starting from a first LSP node in the source LSP chain table, downward via LSP nodes one by one until the network request is transmitted to other protocol layers such as TCP/IP protocol layer.

However, in the present invention, the source LSP chain table may be first converted before the first network request of the browser is sent out. First, a source LSP chain table is copied, for example, an order DLL file in the source LSP chain table is copied, wherein the copied version serves as a first LSP chain table for subsequent processing.

Step 120: converting a source node to which access is not permitted, in the first layered service provider chain table, into a virtual node to obtain a converted second layered service provider chain table; wherein the virtual node implements an interface with each layered service provider and returns a null value; and

It could be determined, one by one, whether each node in the first LSP chain table obtained by copying is the source node to which access is not permitted. The source node may be determined according to a name of a node. For example, the name of an LSP name is mswsock.dll, then the source node may be determined according to a whitelist or blacklist. For example, the name of a source node to which access is permitted is written into the whitelist, when each node in the first LSP chain table is not in the whitelist, access to the source node is not permitted, or it may be understood that the DLL of the LSP node is not permitted to be added. In this embodiment of the present invention, only default LSP node names in system initial situation may be written into the whitelist. Of course, LSP node names injected by other secure application programs may be written into the whitelist, which may be updated via a server. In the same way, the blacklist of an LSP node may be constructed.

In this embodiment of the present invention, the source node to which access is not permitted may be converted into a virtual node (namely, fake.dll). The virtual LSP node may implement all interfaces of the LSP, the network request transmitted by a previous node of the virtual node may normally access the virtual node. The virtual node does not process the network request, namely, the virtual node returns a null value NULL, and then continues to transmit the network request downward. Therefore, a situation of failure in surfing the Internet resulted from an abnormality in sending the network request does not occur in the virtual node. A second LSP chain table is obtained after the source node to which access is not permitted is replaced with the virtual node.

Step 130: controlling a network request of the current browser to be transmitted by means of the second layered service provider chain table.

The network request of the browser may be controlled to be transmitted by means of the second LSP chain table.

In the process of transmitting the network request of the browser outward, the network request needs to be first processed by an LSP chain table so as to be transmitted downward to a communication protocol layer (such as TCP/IP layer), and then the network request is transmitted outside. In the traditional technologies, a customized LSP node may be injected into the LSP chain table to hijack and process the network request of the browser, which may cause a problem of security risk. No matter how other application programs inject LSP nodes, in this embodiment of the present invention, before the browser sends a first network request, the source LSP chain table, in the system, including the LSP node injected by the application program may be replaced with the second LSP chain table, and a source node to which access is not needed is replaced with a virtual node. It may be guaranteed that a network request issued by the browser can be transmitted via a secure LSP chain table no matter how many LSP nodes are injected by how many application programs. Therefore, security of the browser can be improved.

### Embodiment II

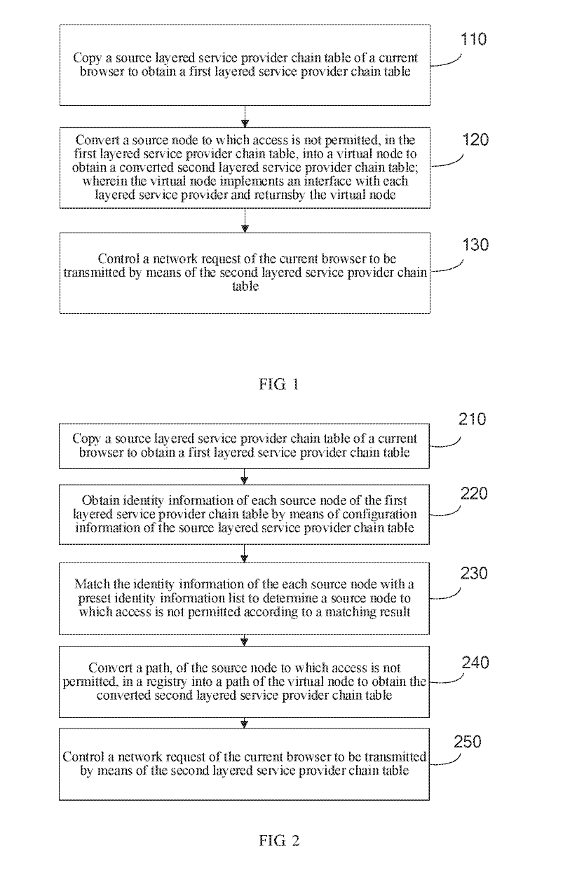

Referring to FIG. 2, which illustrates a schematic flowchart of another browser injection prevention method according to the present invention, the method specifically may include following steps.

Step 210: copying a source layered service provider chain table of a current browser to obtain a first layered service provider chain table.

For example, the source LSP chain table is: A.dll->B.dll->C.dll->D.dll, and the first LSP chain table obtained by copying is A.dll->B.dll->C.dll->D.dll. Of course, in this embodiment of the present invention, a path of each source node recorded in the registry may be searched according to the configuration information of the source LSP chain table of the browser, and then each source node of the source LSP chain table may be copied via the path.

Step 220: obtaining identity information of each source node of the first layered service provider chain table by means of configuration information of the source layered service provider chain table.

Each node in the first LSP chain table is identical to each node of the source LSP chain table. Therefore, identity information of each source node of the first layered service provider chain table may be obtained by reading configuration information of the source LSP chain table. The identity information of each source node generally is stored in the configuration information of the source LSP chain table, for example, information such as registry entry and record name and order recorded for each node. In this embodiment of the present invention, the identity information of each node may be determined according to the configuration information, such as the name thereof. For example, in the above example, the obtained identity information of each node in each of the first LSP chain tables may be A, B, C and D in order.

Step 230: matching the identity information of the each source node with a preset identity information list to determine a source node to which access is not permitted according to a matching result.

In this embodiment of the present invention, an identity information whitelist or an identity information blacklist may be constructed to match the identity information of the each source node. For example, when [A, D] is set up in the whitelist, A, B, C and D are respectively matched with the whitelist, and the source nodes whose names are B and C may be determined as source nodes to which access is not permitted.

Step 240: converting a path, of the source node to which access is not permitted, in a registry into a path of the virtual node to obtain the converted second layered service provider chain table.

In this embodiment of the present invention, the virtual node may be set up in advance, for example fake.dll, storage and specified path.

When the source node is used, the source node needs to be loaded by means of the path of the source node recorded in the registry entry corresponding to the registry, and the path, of the source node to which access is not permitted, in the registry entry corresponding to the registry may be replaced with the path of the virtual node.

In this embodiment of the present invention, a virtual node may be set up for all source node to which access is not permitted, and paths, of the source nodes to which access is not permitted, in the registry entry corresponding to the registry may be replaced with the path of the virtual node, for example, the path of fake.dll. Of course, a corresponding number of virtual nodes may be copied by taking a virtual node initially set as a blueprint according to the number of determined source nodes to which access is not permitted, and file names of the virtual nodes are modified to be different. For example, in the preceding example there are two nodes B and C, two virtual nodes fake1.dll and fake2.dll may be obtained by copying, each virtual node having a path, the registry path of B.dll is modified into the path of fake1.dll, and the registry path of C.dll is modified into the path of fake2.dll.

In this way, the second LSP chain table is obtained, source nodes that are permitted to be loaded in the chain table are reserved, and source nodes that are not permitted to be loaded in the chain table are converted into the virtual nodes.

Steps 220-240 are preferred embodiments of Step 120 according to Embodiment I.

Step 250: controlling a network request of the current browser to be transmitted by means of the second layered service provider chain table.

After the second LSP chain table is obtained and before the browser needs to transmit the network request for the first time, loading may be conducted according to the second LSP chain table, and the network request may be transmitted via the second LSP chain table.

Preferably, the controlling a network request of the current browser to be transmitted by means of the second layered service provider chain table comprises following substeps.

Substep 251: searching a dynamic link library of each node of the second layered service provider chain table from a registry according to configuration information of the source layered service provider chain table and loading the dynamic link library.

In this embodiment of the present invention, the configuration information of the source layered service provider chain table of the browser is not modified, but only node path corresponding to the configuration information and node content are modified. When the browser acquires a corresponding dll according to the configuration information of the LSP chain table, for the configuration information of the source node whose path is replaced, the virtual node may be loaded from the path recorded in the registry entry thereof. Finally, the second LSP chain table is loaded, but the dll of the real source node to which access is not permitted is not loaded.

No matter how other application programs inject LSP nodes, in this embodiment of the present invention, before the browser sends a first network request, the source LSP chain table, in the system, including the LSP node injected by the application program may be replaced with the second LSP chain table, and a source node to which access is not needed is replaced with a virtual node. It may be guaranteed that a network request issued by the browser can be transmitted via a secure LSP chain table no matter how many LSP nodes are injected by how many application programs. Therefore, security of the browser can be improved.

### Embodiment III

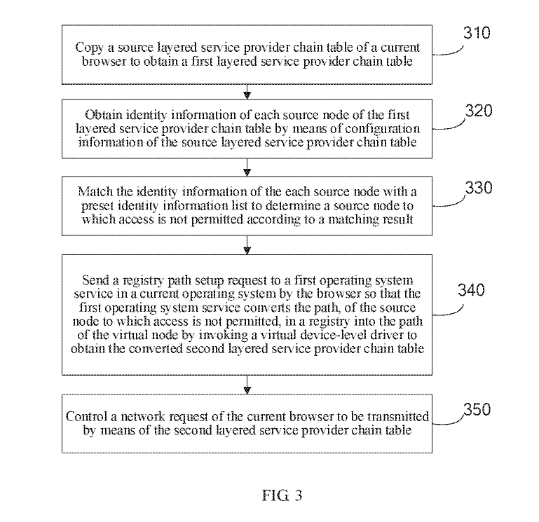

Referring to FIG. 3, which illustrates a schematic flowchart of another browser injection prevention method according to the present invention, the method specifically may include following steps.

Step 310: copying a source layered service provider chain table of a current browser to obtain a first layered service provider chain table.

Step 320: obtaining identity information of each source node of the first layered service provider chain table by means of configuration information of the source layered service provider chain table.

Step 330: matching the identity information of the each source node with a preset identity information list to determine a source node to which access is not permitted according to a matching result.

Step 340: sending a registry path setup request to a first operating system service in a current operating system by the browser so that the first operating system service converts the path, of the source node to which access is not permitted, in a registry into the path of the virtual node by invoking a virtual device-level driver to obtain the converted second layered service provider chain table.

In this embodiment of the present invention, a permission level of the browser is lower, and a registry path setup request may be directly sent to a first operating system service in a current operating system so that the first operating system service converts the path, of the source node to which access is not permitted, in a registry into the path of the virtual node set up in advance by invoking a virtual device-level driver. In this way, the second LSP chain table is obtained finally. The registry path setup request includes registry location information of a node to which access is not permitted and the path of a virtual node corresponding to the node to which access is not permitted.

Preferably, Step S300 may be further included: obtaining and installing an installation file of the first operating system service by the browser to obtain the first operating system service in the current operating system.

In this embodiment of the present invention, a source node to which access is not permitted, in the first layered service provider chain table is converted into a virtual node via the browser. As a user-level permission, the browser has a lower permission level, which may likely exceed permission setting of the system and thus cause failure of executing the conversion. Therefore, conversion permission needs to be improved in form of service.

In the present invention, the browser may acquire in advance and install the installation file of the first operating system service. After being restarted, the service may be randomly started. The service has a relatively high permission level in the operating system, and thus may be less restricted in executing the above operation.

Of course, in this embodiment of the present invention, also it may be determined, in an implementation process, whether the first operating system service has been installed. That is, preferably, obtaining and installing an installation file of the first operating system service by the browser to obtain the first operating system service in the current operating system include following substeps.

Substep S301: determining whether the first operating system service exists; and obtaining and installing an installation file of the first operating system service to obtain the first operating system service in the current operating system when the first operating system service does not exist.

As a process, the first operating system service also has information such as a process name after being started. The browser may search, from the operating system, whether the process name of the first operating system service is present in the currently started processes. When the process name is present, this indicates that the first operating system service has been installed. Otherwise, the first operating system service has not been installed yet.

Preferably, obtaining and installing an installation file of the first operating system service by the browser to obtain the first operating system service in the current operating system include following substeps.

Substep S302: obtaining the installation file of the first operating system service, and installing a dynamic link library of the first operating system service and the virtual device-level driver by means of the installation file of the first operating system service.

In practice, the installation file of the first operating system service further includes the virtual device-level driver, which may be installed along with the installation file. When the first operating system service is not in use, the virtual device-level driver may be not invoked via logic in the dll.

The virtual device-level driver belongs to a kernel-level program and has a highest permission of the operating system. Therefore, replacement of the source node may be executed may be more easily executed by the virtual device-level driver.

Substep S303: starting a process where the first operating system service is to load the dynamic link library of the first operating system service; and invoking the virtual device-level driver by the first operating system service by means of the dynamic link library.

When in installation, the first operating system service may generate a dll file in the system (sys) file, and write relevant parameters of the dll into the registry of the operating system service. Meanwhile, the sys file of the virtual device-level driver may be installed in the operating system, and the relevant parameters of the sys file may be written into the registry. After the operating system is started, an exe file of the first operating system service may be started to wait for notification of a browser process.

Preferably, converting a path, of the source node to which access is not permitted, in a registry into a path of the virtual node by the first operating system service by invoking a virtual device-level driver includes following substeps:

Substep S341: when receiving the registry path setup request, creating, by the first operating system service according to the registry path setup request, an I/O request packet, and sending the I/O request packet to the virtual device-level driver.

In this embodiment of the present invention, the first operating system service may be started as the system is started and may keep running to monitor whether a request sent by the browser is received. When receiving the registry path setup request sent by the browser, an I/O request packet (IRP) may be created according to the registry path setup request and sent down to the virtual device-level driver. An instruction transmitted by the Windows operation system from an application layer to a bottom driver is transmitted by means of the I/O request packet. The first operating system service invokes the virtual device-level driver in this embodiment of the present invention, an IRP needs to be constructed for the purpose of the device-level driver, and then the IRP is sent down to the device-level driver. The IRP includes an instruction controlling the device-level driver to convert a path, of the source node to which access is not permitted, in a registry into a path of the virtual node, for example, including information of the registry entry of the node to which access is not permitted, and information such as the path of the virtual node corresponding to the node to which access is not permitted.

Substep S342: after receiving the I/O request packet, converting, by the virtual device-level driver by invoking a registry modification function, the path, of the source node to which access is not permitted, in a registry into the path of the virtual node.

After the virtual device-level driver determines that the program receives the I/O request packet sent by the first operating system service, an instruction in the I/O request packet is resolved to obtain the information of the registry entry of the node to which access is not permitted and the path information of the virtual node corresponding to the node to which access is not permitted. The path, of the source node to which access is not permitted, in a registry may be converted into the path of the virtual node by invoking the registry modification function.

The path, of the source node to which access is not permitted, in a registry may be converted into the path of the virtual node by means of the registry modification function RegSetValueEx( ) The function prototype of RegSetValueEx( ) is:
RegSetValueEx(
HKEY hKey,// opening the current handle, which may be one of five root keys of the registry
LPCTSTR lpValueName,// character string typed pointer, value entry name pointing to a set key value
LPDWORD lpReserved,// retention value, generally being 0
DWORD dwType,// type of numerical value of to-be-set key value entry
const BYTE *lpData,// pointer directing to buffer area where set numerical value is, or may be set as NULL
DWORD cbData);// length of buffer area where data lpData is specified, taking byte as unit.

The converted second layered service provider chain table may be obtained through the above mentioned way.

In this embodiment of the present invention, the first operating system service may be installed as a part of processes of the browser when the browser is installed, serving as a functional module of the browser.

Step 340 is a preferred embodiment of Step 240 according to Embodiment II.

Step 350: controlling a network request of the current browser to be transmitted by means of the second layered service provider chain table.

No matter how other application programs inject LSP nodes, in this embodiment of the present invention, before the browser sends a first network request, the source LSP chain table, in the system, including the LSP node injected by the application program may be replaced with the second LSP chain table, and a source node to which access is not needed is replaced with a virtual node. It may be guaranteed that a network request issued by the browser can be transmitted via a secure LSP chain table no matter how many LSP nodes are injected by how many application programs. Therefore, security of the browser can be improved. In this embodiment of the present invention, the path, of the source node to which access is not permitted, in a registry is converted into the path of the virtual node by the first operating system service by invoking a virtual device-level driver to obtain the second LSP chain table, and the conversion is carried out with kernel-level permission, thereby avoiding a failed conversion caused by limit of conversion permission by the operating system.

### Embodiment IV

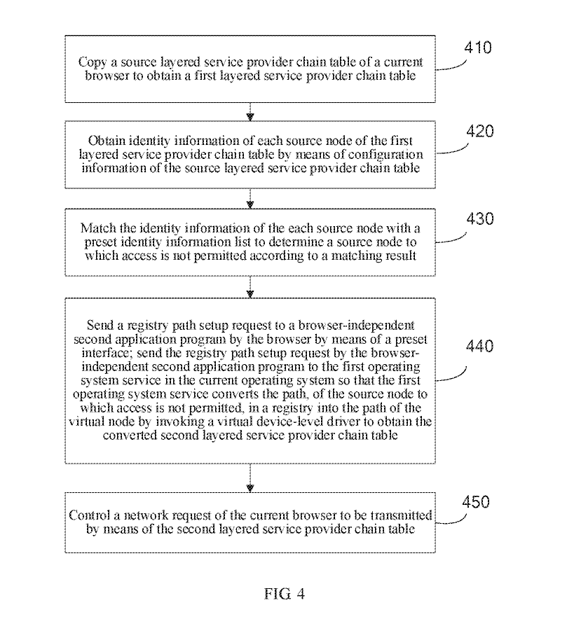

Referring to FIG. 4, which illustrates a schematic flowchart of another browser injection prevention method according to the present invention, the method specifically may include following steps.

Step 410: copying a source layered service provider chain table of a current browser to obtain a first layered service provider chain table.

Step 420: obtaining identity information of each source node of the first layered service provider chain table by means of configuration information of the source layered service provider chain table.

Step 430: matching the identity information of the each source node with a preset identity information list to determine a source node to which access is not permitted according to a matching result.

Step 440: sending a registry path setup request to a browser-independent second application program by the browser by means of a preset interface.

Step 450: sending the registry path setup request by the browser-independent second application program to the first operating system service in the current operating system so that the first operating system service converts the path, of the source node to which access is not permitted, in a registry into the path of the virtual node by invoking a virtual device-level driver to obtain the converted second layered service provider chain table.

In this embodiment of the present invention, the browser is not provided with the function of the first operating system service, but the browser-independent second application program is provided with the function of the first operating system service, for example, programs such as 360 Safeguard and 360 WebShield. The browser may send the registry path setup request to the independent second application program by means of a preset external interface. The registry path setup request includes registry location information of a node to which access is not permitted and the path of a virtual node corresponding to the node to which access is not permitted. The browser-independent second application program sends the registry path setup request to the first operating system service in the current operating system so that the first operating system service converts the path, of the source node to which access is not permitted, in a registry into the path of the virtual node by invoking a virtual device-level driver to obtain the converted second layered service provider chain table.

Steps 440-450 are preferred embodiments of Step 240 according to Embodiment II.

Step 460: controlling a network request of the current browser to be transmitted by means of the second layered service provider chain table.

No matter how other application programs inject LSP nodes, in this embodiment of the present invention, before the browser sends a first network request, the source LSP chain table, in the system, including the LSP node injected by the application program may be replaced with the second LSP chain table, and a source node to which access is not needed is replaced with a virtual node. It may be guaranteed that a network request issued by the browser can be transmitted via a secure LSP chain table no matter how many LSP nodes are injected by how many application programs. Therefore, security of the browser can be improved. In this embodiment of the present invention, using the permission of a third-party application program, the path, of the source node to which access is not permitted, in a registry is converted into the path of the virtual node by the first operating system service by invoking a virtual device-level driver to obtain the second LSP chain table, and the conversion is carried out with kernel-level permission, thereby avoiding a failed conversion caused by limit of conversion permission by the operating system.

### Embodiment V

Referring to FIG. 5, which illustrates a schematic flowchart of another browser injection prevention method according to the present invention, the method specifically may include following steps.

Step 510: copying a source layered service provider chain table of a current browser to obtain a first layered service provider chain table.

Step 520: obtaining identity information of each source node of the first layered service provider chain table by means of configuration information of the source layered service provider chain table.

Step 530: matching the identity information of the each source node with a preset identity information list to determine a source node to which access is not permitted according to a matching result.

Step 540: sending a registry path setup request to a first operating system service in a current operating system by the browser.

Step 550: determining by the first operating system service whether a sender of the registry path setup request is a specified browser; entering into Step 552 when the sender of the registry path setup request is not the specified browser; or entering into Step 554 when the sender of the registry path setup request is the specified browser.

Step 552: not entering into subsequent processing.

Step 554: creating an I/O request packet according to the registry path setup request and sending the I/O request packet to the virtual device-level driver.

In this embodiment of the present invention, to prevent a browser not selected by a user or a browser cooperating with a third party from using the injection prevention function mentioned in this embodiment of the present invention and from increasing system resource consumption, a whitelist may be set up in the first operating system service for the browser. Next, the identity information of the sender of the registry path setup request is acquired and matched with the browser whitelist recorded in the first operating system service. An injection prevention process is not entered into when the matching fails. Otherwise, an I/O request packet is created according to the registry path setup request and sent down to the virtual device-level driver.

Preferably, the registry path setup request includes identity authentication information of the browser. The identity authentication information includes, for example, a browser name, namely signature information of the browser, or of course may be other unique identity authentication information.

Further, determining by the first operating system service whether a sender of the registry path setup request is a specified browser includes:

Substep S5501: resolving the identity authentication information in the registry path setup request, matching the identity authentication information with prestored identity authentication information; and determining that the sender of the registry path setup request is the specified browser when the matching is successful.

The browser name is matched with a browser name recorded in the first operating system service, or the signature information of the browser is matched with signature information of the browser recorded in the first operating system service. The sender of the registry path setup request may be regarded as the specified browser when the matching succeeds, and the device-level driver may be utilized to execute the injection prevention function.

Step 560: after receiving the I/O request packet, converting, by the virtual device-level driver by invoking a registry modification function, the path, of the source node to which access is not permitted, in a registry into the path of the virtual node to obtain a converted second layered service provider chain table.

Step 570: controlling a network request of the current browser to be transmitted by means of the second layered service provider chain table.

### Embodiment VI

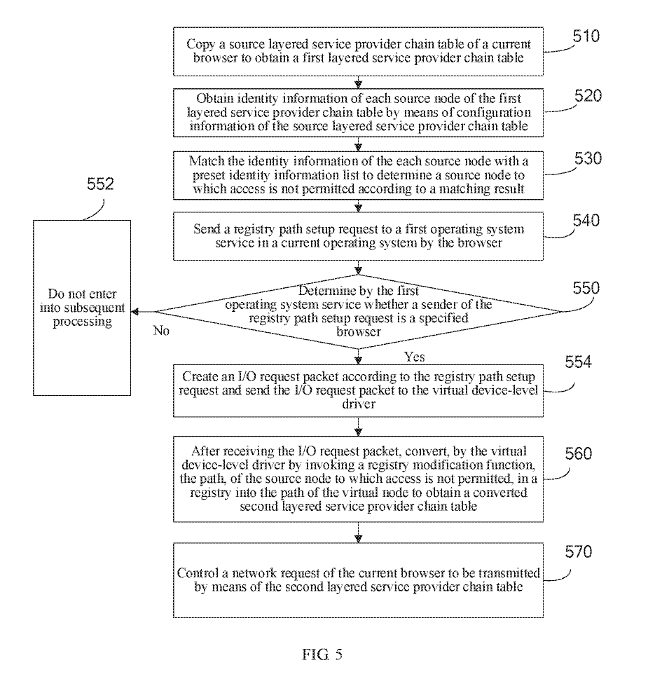

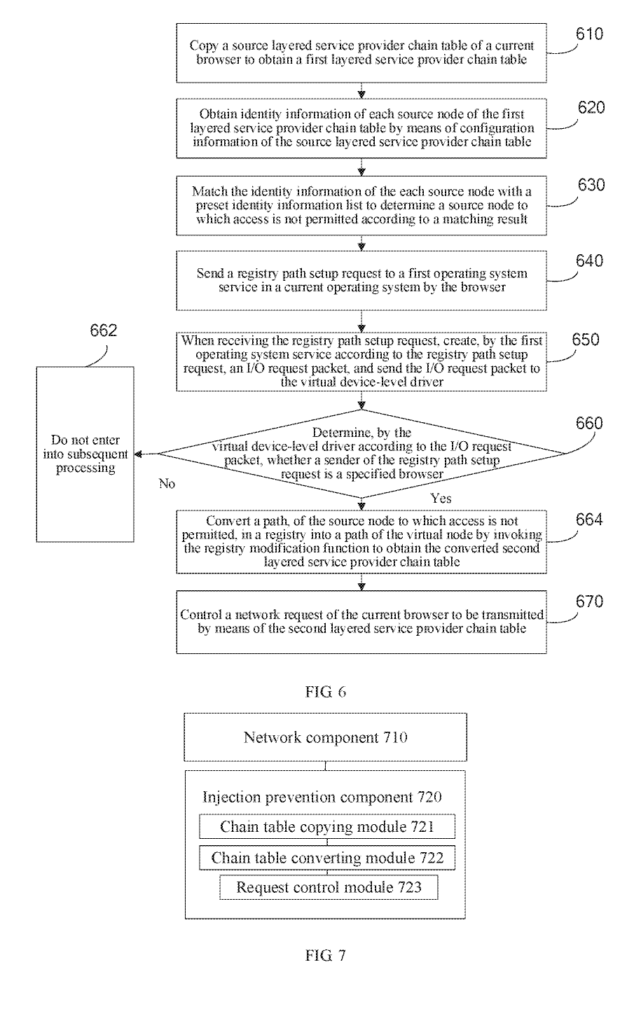

Referring to FIG. 6, which illustrates a schematic flowchart of another browser injection prevention method according to the present invention, the method specifically may include following steps.

Step 610: copying a source layered service provider chain table of a current browser to obtain a first layered service provider chain table.

Step 620: obtaining identity information of each source node of the first layered service provider chain table by means of configuration information of the source layered service provider chain table.

Step 630: matching the identity information of the each source node with a preset identity information list to determine a source node to which access is not permitted according to a matching result.

Step 640: sending a registry path setup request to a first operating system service in a current operating system by the browser.

Step 650: when receiving the registry path setup request, creating, by the first operating system service according to the registry path setup request, an I/O request packet, and sending the I/O request packet to the virtual device-level driver.

Step 660: determining, by the virtual device-level driver according to the I/O request packet, whether a sender of the registry path setup request is a specified browser; entering into Step 662 when the sender of the registry path setup request is not the specified browser; or entering into Step 664 when the sender of the registry path setup request is the specified browser.

Step 662: not entering into subsequent processing.

Step 664: converting a path, of the source node to which access is not permitted, in a registry into a path of the virtual node by invoking the registry modification function to obtain the converted second layered service provider chain table.

In this embodiment of the present invention, to prevent a browser not selected by a user or a browser cooperating with a third party from using the injection prevention function mentioned in this embodiment of the present invention and from increasing system resource consumption, a whitelist may be set up in the virtual device-level driver for the browser. Next, the identity information of the sender of the registry path setup request is acquired according to the I/O request packet and matched with the browser whitelist recorded in the virtual device-level driver. An injection prevention process is not entered into when the matching fails. Otherwise, an I/O request packet is created according to the registry path setup request and sent down to the virtual device-level driver.

Preferably, the registry path setup request includes identity authentication information of the browser. The identity authentication information includes, for example, a browser name, namely signature information of the browser, or of course may be other unique identity authentication information.

Further, determining by the virtual device-level driver whether a sender of the registry path setup request is a specified browser according to the I/O request packet includes following substeps.

Substep S6601: receiving, by the virtual device-level driver, an I/O request packet sent by the first operating system service; the I/O request packet including the identity authentication information of the browser.

The browser may transmit the registry path setup request to the first operating system service. The first operating system service may repackage the registry path setup request into an IRP based on registry location information of a node to which access is not permitted included in the registry path setup request, the path of the virtual node corresponding to the node to which access is not permitted, and the identity authentication information of the browser, and then transmit the IRP to the device-level driver.

Substep S6602: resolving the identity authentication information in the I/O request packet, matching the identity authentication information with prestored identity authentication information; and determining that the sender of the registry path setup request is the specified browser when the matching is successful.

After receiving the I/O request packet sent by the first operating system service, the device-level driver may resolve the registry location information of the node to which access is not permitted included in the I/O request packet, the path of the virtual node corresponding to the node to which access is not permitted, and the identity authentication information of the browser, and then match the identity authentication information with prestored identity authentication information. The sender of the registry path setup request is determined as the specified browser when the matching is successful.

Step 670: controlling a network request of the current browser to be transmitted by means of the second layered service provider chain table.

### Embodiment VII

Referring to FIG. 7, which illustrates a schematic structural diagram of a browser client according to the present invention, the browser client specifically may include:
a network component 710, configured to initiate a network request to be sent to a server;
an injection prevention component 720, specifically including:
a chain table copying module 721, configured to copy a source layered service provider chain table of a current browser to obtain a first layered service provider chain table;
a chain table converting module 722, configured to convert a source node to which access is not permitted, in the first layered service provider chain table, into a virtual node to obtain a converted second layered service provider chain table; wherein the virtual node implements an interface with each layered service provider and returns a null value; and
a request control module 723, configured to control the network request to be transmitted by means of the second layered service provider chain table.

### Embodiment VIII

Referring to FIG. 8, which illustrates a schematic structural diagram of a browser client according to the present invention, the browser client specifically may include:
a network component 810, configured to initiate a network request to be sent to a server;
an injection prevention component 820, specifically including:
a chain table copying module 821, configured to copy a source layered service provider chain table of a current browser to obtain a first layered service provider chain table;
a chain table converting module 822, configured to convert a source node to which access is not permitted, in the first layered service provider chain table, into a virtual node to obtain a converted second layered service provider chain table; wherein the virtual node implements an interface with each layered service provider and returns a null value; specifically including:
a source node identity searching module 8221, configured to obtain identity information of each source node of the first layered service provider chain table by means of configuration information of the source layered service provider chain table;
a source node conversion determining module 8222, configured to match the identity information of the each source node with a preset identity information list to determine a source node to which access is not permitted according to a matching result; and
a source node converting module 8223, configured to convert a path, of the source node to which access is not permitted, in a registry into a path of the virtual node; and
a request control module 823, configured to control the network request to be transmitted by means of the second layered service provider chain table.

Preferably, the request control module 823 includes:
a second chain table loading module, configured to search a dynamic link library of each node of the second layered service provider chain table from a registry according to the configuration information of the source layered service provider chain table and load the dynamic link library.

### Embodiment IX

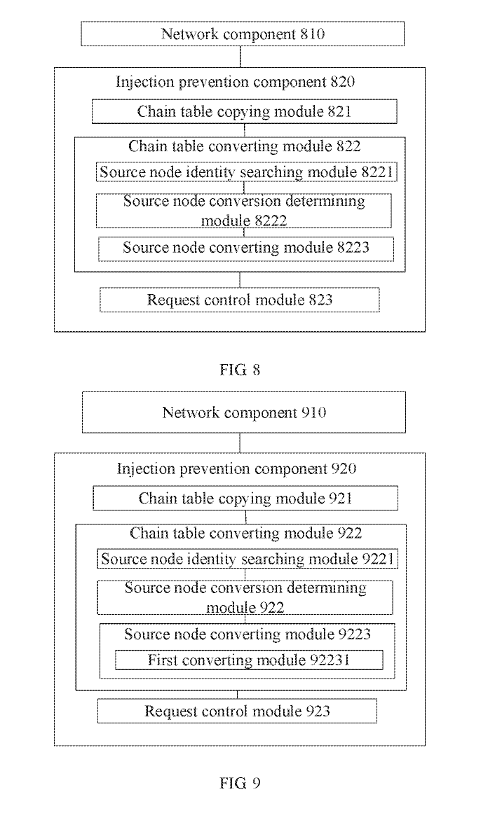

Referring to FIG. 9, which illustrates a schematic structural diagram of a browser client according to the present invention, the browser client specifically may include:
a network component 910, configured to initiate a network request to be sent to a server;
an injection prevention component 920, specifically including:
a chain table copying module 921, configured to copy a source layered service provider chain table of a current browser to obtain a first layered service provider chain table;
a chain table converting module 922, configured to convert a source node to which access is not permitted, in the first layered service provider chain table, into a virtual node to obtain a converted second layered service provider chain table; wherein the virtual node implements an interface with each layered service provider and returns a null value; specifically including:
a source node identity searching module 9221, configured to obtain identity information of each source node of the first layered service provider chain table by means of configuration information of the source layered service provider chain table;
a source node conversion determining module 9222, configured to match the identity information of the each source node with a preset identity information list to determine a source node to which access is not permitted according to a matching result; and
a source node converting module 9223, including:
a first converting module 92231, configured to send a registry path setup request to a first operating system service in a current operating system by the browser so that the first operating system service converts the path, of the source node to which access is not permitted, in a registry into the path of the virtual node by invoking a virtual device-level driver; and
a request control module 923, configured to control the network request to be transmitted by means of the second layered service provider chain table.

Preferably, the browser client further includes:
a service installing module, configured to obtain and install an installation file of the first operating system service by the browser to obtain the first operating system service in the current operating system.

Preferably, the first converting module includes:
an externally sending module, configured to send a registry path setup request to a browser-independent second application program by the browser by means of a preset interface, and send the registry path setup request to the first operating system service in the current operating system by the browser-independent second application program so that the first operating system service converts the path, of the source node to which access is not permitted, in a registry into the path of the virtual node by invoking a virtual device-level driver.

Preferably, the service installing module further includes:
a first installing module, configured to obtain the installation file of the first operating system service, and install a dynamic link library of the first operating system service and the virtual device-level driver by means of the installation file of the first operating system service; and
a service starting module, configured to start a process where the first operating system service is to load the dynamic link library of the first operating system service; the first operating system service invoking the virtual device-level driver by means of the dynamic link library.

Preferably, the first converting module further includes:
a service determining module, configured to determine whether the first operating system service exists; and obtain and install an installation file of the first operating system service to obtain the first operating system service in the current operating system when the first operating system service does not exist.

Preferably, the first converting module includes:
a request converting module, configured to create, when receiving the registry path setup request by the first operating system service, an I/O request packet according to the registry path setup request, and send the I/O request packet to the virtual device-level driver; and
a second converting module, configured to convert by invoking a registry modification function, after receiving the I/O request packet by the virtual device-level driver, the path, of the source node to which access is not permitted, in a registry into the path of the virtual node.

### Embodiment X

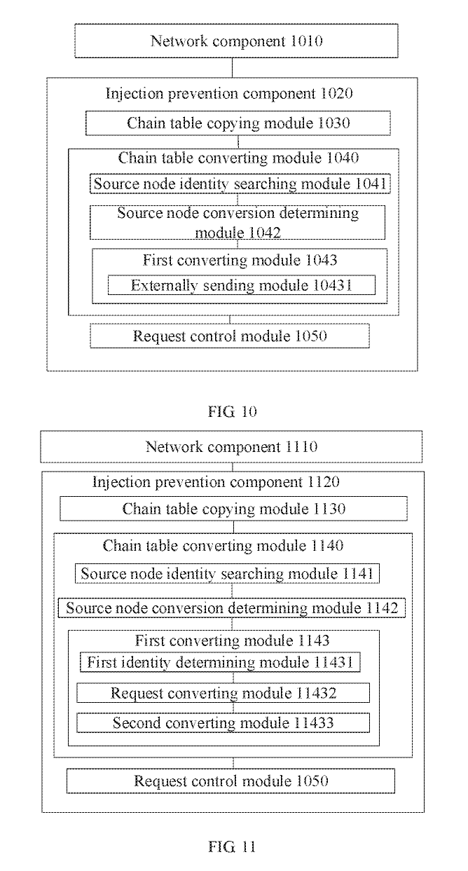

Referring to FIG. 10, which illustrates a schematic structural diagram of a browser client according to the present invention, the browser client specifically may include:
a network component 1010, configured to initiate a network request to be sent to a server;
an injection prevention component 1020, specifically including:
a chain table copying module 1030, configured to copy a source layered service provider chain table of a current browser to obtain a first layered service provider chain table;
a chain table converting module 1040, configured to convert a source node to which access is not permitted, in the first layered service provider chain table, into a virtual node to obtain a converted second layered service provider chain table; wherein the virtual node implements an interface with each layered service provider and returns a null value; specifically including:
a source node identity searching module 1041, configured to obtain identity information of each source node of the first layered service provider chain table by means of configuration information of the source layered service provider chain table;
a source node conversion determining module 1042, configured to match the identity information of the each source node with a preset identity information list to determine a source node to which access is not permitted according to a matching result; and
a first converting module 1043, specifically including:
an externally sending module 10431, configured to send a registry path setup request to a browser-independent second application program by the browser by means of a preset interface, and send the registry path setup request to the first operating system service in the current operating system by the browser-independent second application program so that the first operating system service converts the path, of the source node to which access is not permitted, in a registry into the path of the virtual node by invoking a virtual device-level driver; and
a request control module 1050, configured to control the network request to be transmitted by means of the second layered service provider chain table.

### Embodiment XI

Referring to FIG. 11, which illustrates a schematic structural diagram of a browser client according to the present invention, the browser client specifically may include:
a network component 1110, configured to initiate a network request to be sent to a server;
an injection prevention component 1120, specifically including:
a chain table copying module 1130, configured to copy a source layered service provider chain table of a current browser to obtain a first layered service provider chain table;
a chain table converting module 1140, configured to convert a source node to which access is not permitted, in the first layered service provider chain table, into a virtual node to obtain a converted second layered service provider chain table; wherein the virtual node implements an interface with each layered service provider and returns a null value; specifically including:
a source node identity searching module 1141, configured to obtain identity information of each source node of the first layered service provider chain table by means of configuration information of the source layered service provider chain table;
a source node conversion determining module 1142, configured to match the identity information of the each source node with a preset identity information list to determine a source node to which access is not permitted according to a matching result; and
a first converting module 1143, specifically including:
a first identity determining module 11431, configured to determine by the first operating system service whether a sender of the registry path setup request is a specified browser before converting a path, of the source node to which access is not permitted, in a registry into a path of the virtual node, and not enter into subsequent processing when the sender of the registry path setup request is not the specified browser; or enter into a request converting module 11432 when the sender of the registry path setup request is the specified browser;
the request converting module 11432, configured to create an I/O request packet according to the registry path setup request and send the I/O request packet to the virtual device-level driver; and
a second converting module 11433, configured to convert by invoking a registry modification function, after receiving the I/O request packet by the virtual device-level driver, the path, of the source node to which access is not permitted, in a registry into the path of the virtual node; and
a request control module 1150, configured to control the network request to be transmitted by means of the second layered service provider chain table.

Preferably, the registry path setup request includes identity authentication information of the browser.

Further, the first identity determining module includes:
a first resolving and determining module, configured to resolve the identity authentication information in the registry path setup request, match the identity authentication information with prestored identity authentication information, and determine that the sender of the registry path setup request is the specified browser when the matching is successful.

### Embodiment XII

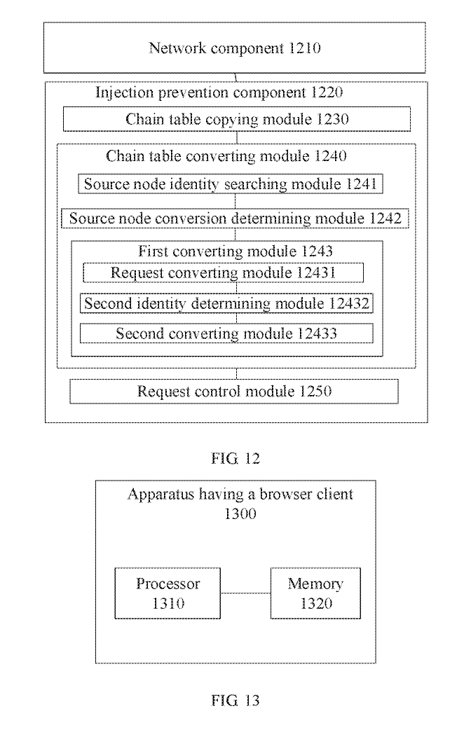

Referring to FIG. 12, which illustrates a schematic structural diagram of a browser client according to the present invention, the browser client specifically may include:
a network component 1210, configured to initiate a network request to be sent to a server;
an injection prevention component 1220, specifically including:
a chain table copying module 1230, configured to copy a source layered service provider chain table of a current browser to obtain a first layered service provider chain table;
a chain table converting module 1240, configured to convert a source node to which access is not permitted, in the first layered service provider chain table, into a virtual node to obtain a converted second layered service provider chain table; wherein the virtual node implements an interface with each layered service provider and returns a null value; specifically including:
a source node identity searching module 1241, configured to obtain identity information of each source node of the first layered service provider chain table by means of configuration information of the source layered service provider chain table;
a source node conversion determining module 1242, configured to match the identity information of the each source node with a preset identity information list to determine a source node to which access is not permitted according to a matching result; and
a first converting module 1243, specifically including:
a request converting module 12431, configured to create, when receiving the registry path setup request by the first operating system service, an I/O request packet according to the registry path setup request, and send the I/O request packet to the virtual device-level driver;
a second identity determining module 12432, configured to determine by the virtual device-level driver, before converting a path, of the source node to which access is not permitted, in a registry into a path of the virtual node, whether a sender of the registry path setup request is a specified browser according to the I/O request packet, and not enter into subsequent processing when the sender of the registry path setup request is not the specified browser, or enter into a second converting module 12433 when the sender of the registry path setup request is the specified browser; and
the second converting module 12433, configured to convert a path, of the source node to which access is not permitted, in a registry into a path of the virtual node by invoking a registry modification function; and
a request control module 1250, configured to control the network request to be transmitted by means of the second layered service provider chain table.

Preferably, the registry path setup request includes identity authentication information of the browser.

Further, the second identity determining module comprises:
an I/O request packet receiving module, configured to receive, by the virtual device-level driver, an I/O request packet sent by the first operating system service; the I/O request packet comprising the identity authentication information of the browser; and
a second resolving and determining module, configured to resolve the identity authentication information in the I/O request packet, match the identity authentication information with prestored identity authentication information, and determine that the sender of the registry path setup request is the specified browser when the matching is successful.

### Embodiment XIII

Referring to FIG. 13, which illustrates a schematic structural diagram of an apparatus having a browser client according to the present invention. The apparatus 1300 having a browser client specifically may include:
a processor 1310, and a memory 1320 loading a plurality of executable instructions, the plurality of instructions including a method for executing following steps:
initiating a network request to be sent to a server;
copying a source layered service provider chain table of a current browser to obtain a first layered service provider chain table;
converting, after acquiring the first layered service provider chain table, a source node to which access is not permitted, in the first layered service provider chain table, into a virtual node to obtain a converted second layered service provider chain table, wherein the virtual node implements an interface with each layered service provider and returns a null value; and
controlling the network request to be transmitted by means of the second layered service provider chain table.

Preferably, the converting a source node to which access is not permitted, in the first layered service provider chain table, into a virtual node includes:
obtaining identity information of each source node of the first layered service provider chain table by means of configuration information of the source layered service provider chain table;
matching the identity information of the each source node with a preset identity information list to determine a source node to which access is not permitted according to a matching result; and
converting a path, of the source node to which access is not permitted, in a registry into a path of the virtual node.

Preferably, the converting a path, of the source node to which access is not permitted, in a registry into a path of the virtual node includes:
sending a registry path setup request to a first operating system service in a current operating system by the browser so that the first operating system service converts the path, of the source node to which access is not permitted, in a registry into the path of the virtual node by invoking a virtual device-level driver.

Of course, the plurality of instructions may further include steps for executing various methods in the preceding embodiments.

Algorithm and display provided herein are not inherently related to a particular computer, virtual system or other equipment. Various general systems may also be used with the teaching based on the present invention. According to the above description, the required structure for constructing such a system is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the present invention and to facilitate the understanding of one or more of various aspects thereof, in the above description of the exemplary embodiments of the present invention, various features of the present invention may sometimes be grouped together into a single embodiment, accompanying figure or description thereof. However, the method of this present invention should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiment can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the browser injection prevention device according to the embodiments of the present invention. The present invention may further be implemented as device or browser client program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

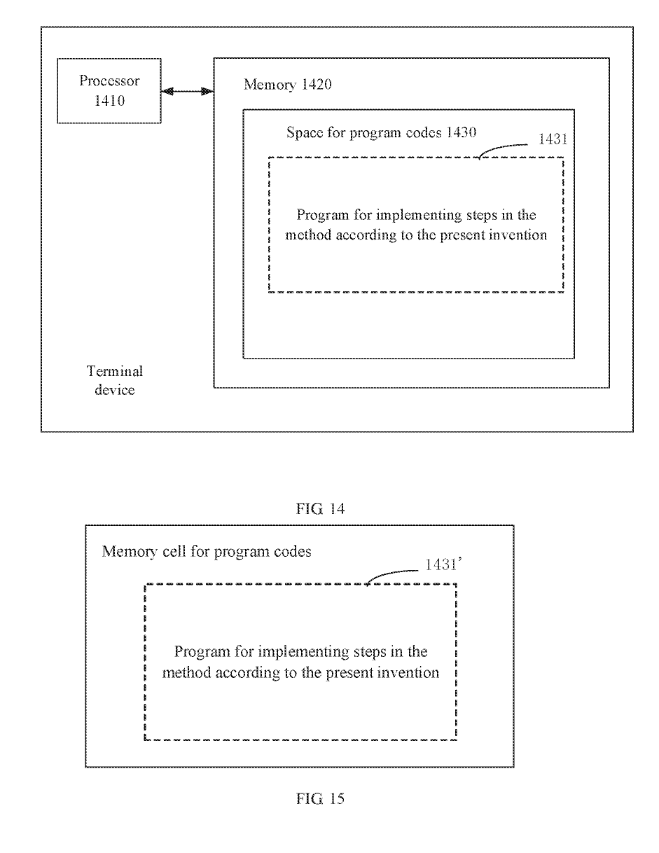

For example, FIG. 14 illustrates a terminal device having a browser client according to the present invention. Traditionally, the terminal device includes a processor 1410 and a computer program product or a computer readable medium in form of a memory 1420. The memory 1420 may be electronic memories such as flash memory, EEPROM (Electrically Erasable Programmable Read-Only Memory), EPROM, hard disk or ROM. The memory 1420 has a memory space 1430 for executing program codes 1431 of any steps in the above methods. For example, the memory space 1430 for program codes may include respective program codes 1431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 15. The memory cells may be provided with memory sections, memory spaces, etc., similar to the memory 1420 of the terminal device as shown in FIG. 14. The program codes may be compressed for example in an appropriate form. Usually, the memory cell includes computer readable codes 1431′ which can be read for example by processors 1410. When these codes are operated on the terminal device, the terminal device may execute respective steps in the method as described above.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “include/comprise” does not exclude a component or step not listed in the claims. The wording “a” or “an” in front of an element does not exclude the presence of a plurality of such elements. The present invention may be realized by means of hardware comprising a number of different components and by means of a suitably programmed computer. In the unit claim listing a plurality of browser clients, some of these browser clients may be embodied in the same hardware. The wordings “first”, “second”, and “third”, etc. do not denote any order. These wordings can be construed as naming. Also, it should be noticed that the language used in the present specification is chosen for the purpose of readability and teaching, rather than explaining or defining the subject matter of the present invention. Therefore, it is apparent to an ordinary skilled person in the art that modifications and variations could be made without departing from the scope and spirit of the claims as appended. For the scope of the present invention, the publication of the present invention is illustrative rather than restrictive, and the scope of the present invention is defined by the appended claims.

1. A browser injection prevention method, comprising:
copying a source layered service provider chain table of a current browser to obtain a first layered service provider chain table;
converting a source node to which access is not permitted, in the first layered service provider chain table, into a virtual node to obtain a converted second layered service provider chain table; wherein the virtual node implements an interface with each layered service provider and returns a null value; and
controlling a network request of the current browser to be transmitted by means of the second layered service provider chain table.

2. The method according to claim 1, wherein converting a source node to which access is not permitted, in the first layered service provider chain table, into a virtual node comprises:
obtaining identity information of each source node of the first layered service provider chain table by means of configuration information of the source layered service provider chain table;
matching the identity information of the each source node with a preset identity information list to determine a source node to which access is not permitted according to a matching result; and
converting a path, of the source node to which access is not permitted, in a registry into a path of the virtual node.

3. The method according to claim 2, wherein the converting a path, of the source node to which access is not permitted, in a registry into a path of the virtual node comprises:
sending a registry path setup request to a first operating system service in a current operating system by the browser so that the first operating system service converts the path, of the source node to which access is not permitted, in a registry into the path of the virtual node by invoking a virtual device-level driver.

4. (canceled)

5. The method according to claim 3, wherein sending a registry path setup request to a first operating system service in a current operating system by the browser comprises:
sending a registry path setup request to a browser-independent second application program by the browser by means of a preset interface; and sending the registry path setup request to the first operating system service in the current operating system by the browser-independent second application program so that the first operating system service converts the path, of the source node to which access is not permitted, in a registry into the path of the virtual node by invoking a virtual device-level driver.

6.-7. (canceled)

8. The method according to claim 3, wherein converting a path, of the source node to which access is not permitted, in a registry into a path of the virtual node by the first operating system service by invoking a virtual device-level driver comprises:
when receiving the registry path setup request, creating, by the first operating system service according to the registry path setup request, an I/O request packet, and sending the I/O request packet to the virtual device-level driver; and
after receiving the I/O request packet, converting, by the virtual device-level driver by invoking a registry modification function, the path, of the source node to which access is not permitted, in a registry into the path of the virtual node.

9. The method according to claim 8, wherein before converting a path, of the source node to which access is not permitted, in a registry into a path of the virtual node, further comprises:
determining by the first operating system service whether a sender of the registry path setup request is a specified browser;
not entering into subsequent processing when the sender of the registry path setup request is not the specified browser; or
creating an I/O request packet according to the registry path setup request and sending the I/O request packet to the virtual device-level driver when the sender of the registry path setup request is the specified browser.

10. The method according to claim 9, wherein the registry path setup request comprises identity authentication information of the browser;
further, determining by the first operating system service whether a sender of the registry path setup request is a specified browser comprises:
resolving the identity authentication information in the registry path setup request, matching the identity authentication information with prestored identity authentication information; and determining that the sender of the registry path setup request is the specified browser when the matching is successful.

11. The method according to claim 8, wherein before converting a path, of the source node to which access is not permitted, in a registry into a path of the virtual node, further comprises:
determining by the virtual device-level driver whether a sender of the registry path setup request is a specified browser according to the I/O request packet;
not entering into subsequent processing when the sender of the registry path setup request is not the specified browser; or
converting, by invoking the registry modification function, the path, of the source node to which access is not permitted, in a registry into the path of the virtual node when the sender of the registry path setup request is the specified browser.

12. The method according to claim 11, wherein the registry path setup request comprises identity authentication information of the browser;
further, determining by the virtual device-level driver whether a sender of the registry path setup request is a specified browser according to the I/O request packet comprises:
receiving, by the virtual device-level driver, an I/O request packet sent by the first operating system service; the I/O request packet comprising the identity authentication information of the browser; and
resolving the identity authentication information in the I/O request packet, matching the identity authentication information with prestored identity authentication information; and determining that the sender of the registry path setup request is the specified browser when the matching is successful.

13. (canceled)

14. A browser client, comprising:
a network component, configured to initiate a network request to be sent to a server;
an injection prevention component, specifically comprising:
a chain table copying module, configured to copy a source layered service provider chain table of a current browser to obtain a first layered service provider chain table;
a chain table converting module, configured to convert a source node to which access is not permitted, in the first layered service provider chain table, into a virtual node to obtain a converted second layered service provider chain table; wherein the virtual node implements an interface with each layered service provider and returns a null value; and
a request control module, configured to control the network request to be transmitted by means of the second layered service provider chain table.

15. The browser client according to claim 14, wherein the chain table converting module comprises:
a source node identity searching module, configured to obtain identity information of each source node of the first layered service provider chain table by means of configuration information of the source layered service provider chain table;
a source node conversion determining module, configured to match the identity information of the each source node with a preset identity information list to determine a source node to which access is not permitted according to a matching result; and
a source node converting module, configured to convert a path, of the source node to which access is not permitted, in a registry into a path of the virtual node.

16. The browser client according to claim 15, wherein the source node converting module comprises:
a first converting module, configured to send a registry path setup request to a first operating system service in a current operating system by the browser so that the first operating system service converts the path, of the source node to which access is not permitted, in a registry into the path of the virtual node by invoking a virtual device-level driver.

17. (canceled)

18. The browser client according to claim 16, wherein the first converting module comprises:
an externally sending module, configured to send a registry path setup request to a browser-independent second application program by the browser by means of a preset interface, and send the registry path setup request to the first operating system service in the current operating system by the browser-independent second application program so that the first operating system service converts the path, of the source node to which access is not permitted, in a registry into the path of the virtual node by invoking a virtual device-level driver.

19.-20. (canceled)

21. The browser client according to claim 16, wherein the first converting module comprises:
a request converting module, configured to create, when receiving the registry path setup request by the first operating system service, an I/O request packet according to the registry path setup request, and send the I/O request packet to the virtual device-level driver; and
a second converting module, configured to convert by invoking a registry modification function, after receiving the I/O request packet by the virtual device-level driver, the path, of the source node to which access is not permitted, in a registry into the path of the virtual node.

22. The browser client according to claim 21, wherein the first converting module further comprises:
a first identity determining module, configured to determine by the first operating system service whether a sender of the registry path setup request is a specified browser before converting a path, of the source node to which access is not permitted, in a registry into a path of the virtual node, and not enter into subsequent processing when the sender of the registry path setup request is not the specified browser; or create an I/O request packet according to the registry path setup request and send the I/O request packet to the virtual device-level driver when the sender of the registry path setup request is the specified browser.

23. The browser client according to claim 22, wherein the registry path setup request comprises identity authentication information of the browser; and
further, the first identity determining module comprises:
a first resolving and determining module, configured to resolve the identity authentication information in the registry path setup request, match the identity authentication information with prestored identity authentication information, and determine that the sender of the registry path setup request is the specified browser when the matching is successful.

24. The browser client according to claim 21, wherein the first converting module further comprises:
a second identity determining module, configured to determine by the virtual device-level driver, before converting a path, of the source node to which access is not permitted, in a registry into a path of the virtual node, whether a sender of the registry path setup request is a specified browser according to the I/O request packet, and not enter into subsequent processing when the sender of the registry path setup request is not the specified browser, or convert, by invoking the registry modification function, the path, of the source node to which access is not permitted, in a registry into the path of the virtual node when the sender of the registry path setup request is the specified browser.

25. The browser client according to claim 24, wherein the registry path setup request comprises identity authentication information of the browser; and
further, the second identity determining module comprises:
an I/O request packet receiving module, configured to receive, by the virtual device-level driver, an I/O request packet sent by the first operating system service; the I/O request packet comprising the identity authentication information of the browser; and
a second resolving and determining module, configured to resolve the identity authentication information in the I/O request packet, match the identity authentication information with prestored identity authentication information, and determine that the sender of the registry path setup request is the specified browser when the matching is successful.

26.-30. (canceled)

31. A computer-readable medium, storing the computer program comprising a computer-readable code, wherein a terminal device is caused to execute the browser injection prevention method according to claim 1 when the computer-readable code runs on the terminal device.
